(19) United States
(12) Patent Application Publication
(10) Pub. No.: US 2024/0326662 A1
(43) Pub. Date: Oct. 3, 2024

(54) CHILD SEAT

(71) Applicant: SUBARU CORPORATION, Tokyo (JP)

(72) Inventor: Isamu NAGASAWA, Tokyo (JP)

(21) Appl. No.: 18/601,613

(22) Filed: Mar. 11, 2024

(30) Foreign Application Priority Data
Mar. 28, 2023 (JP) 2023-051649

(51) Int. Cl. B60N 2/26; B60N 2/00

(52) U.S. Cl. CPC B60N 2/274; B60N 2/0027

(57) ABSTRACT

A child seat to be disposed on a vehicle seat in a vehicle includes sensors, a detector, and a communicator. The sensors are provided on inner sides of surfaces of a seat back and a seat unit corresponding to at least a head, a chest, and an ischium of a child who is seated on the child seat. The surfaces are in contact with the child. The detector is configured to perform a detection of a position of a center of gravity of the seated child based on sensor signals from the sensors. The communicator is configured to transmit a result of the detection by the detector to an external device.

### CROSS-REFERENCE TO RELATED APPLICATIONS

The present application claims priority from Japanese Patent Application No. 2023-051649 filed on Mar. 28, 2023, the entire contents of which are hereby incorporated by reference.

### BACKGROUND

The disclosure relates to a child seat.

In recent years, many cases where a child or the like is left behind in a parked vehicle and an accident occurs have been reported, and these accidents have become a social problem.

For example, in summer in which an influence of unusual weather is great, when a child or the like is left behind in the parked vehicle, there is a possibility of causing a notable situation regardless of day and night.

In order to address such an event, disclosed is an in-vehicle accident prevention device including: an occupant detector that detects an occupant in a vehicle; an abnormality detector that detects an abnormality in the vehicle; and a controller that controls a warning device to warn an inside or an outside of the vehicle or controls in-vehicle equipment to mitigate the abnormality in the vehicle when the occupant detector detects the occupant and the abnormality detector detects the abnormality. The occupant detector extracts physical characteristics or behavioral characteristics of the occupant in the vehicle to further detect a type of the occupant or whether the occupant is able to cope with the abnormality. The controller executes the warning by the warning device or the abnormality mitigation by the in-vehicle equipment according to the type or a state of the occupant detected by the occupant detector (for example, refer to Japanese Unexamined Patent Application Publication (JP-A) No. 2020-93684).

### SUMMARY

An aspect of the disclosure provides a child seat to be disposed on a vehicle seat in a vehicle. The child seat includes sensors, a detector, and a communicator. The sensors are provided on inner sides of surfaces of a seat back and a seat unit corresponding to at least a head, a chest, and an ischium of a child who is seated on the child seat. The surfaces are in contact with the child. The detector is configured to perform a detection of a position of a center of gravity of the seated child based on sensor signals from the sensors. The communicator is configured to transmit a result of the detection by the detector to an external device.

An aspect of the disclosure provides a child seat to be disposed on a vehicle seat in a vehicle. The child seat includes: sensors provided on inner sides of surfaces of a seat back and a seat unit corresponding to at least a head, a chest, and an ischium of a child who is seated on the child seat, the surfaces being in contact with the child; and circuitry configured to perform a detection of a position of a center of gravity of the seated child based on sensor signals from the sensors, and cause a communicator to transmit a result of the detection to an external device.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 illustrates a configuration of a child seat according to an embodiment of the disclosure.

FIG. 2 illustrates a power supply structure to the child seat according to the embodiment of the disclosure.

FIG. 3 illustrates an electrical configuration of the child seat according to the embodiment of the disclosure.

FIG. 4 is a process flowchart of the child seat according to the embodiment of the disclosure.

FIG. 5 is a process flowchart of the child seat according to the embodiment of the disclosure.

### DETAILED DESCRIPTION

In the technique described in JP-A No. 2020-93684, the warning by the warning device or the abnormality mitigation by the in-vehicle equipment is executed according to the type or the state of the occupant detected by the occupant detector.

However, in the technique described in JP-A No. 2020-93684, when the occupant who is left behind in a parked vehicle is a child and a cloth or the like is put on a child seat, the child may not be detected from an image or the like in the first place.

Although not disclosed in JP-A No. 2020-93684, a delicate movement of the child may not be grasped even when sensing by a millimeter-wave radar or the like is used.

Furthermore, since the child may not be able to escape to the outside of the vehicle by himself or herself and is also inferior in physical strength, it is urgent to take a measure for the child left in the parked vehicle, but the technique described in JP-A No. 2020-93684 has a problem that the technique takes time to take an emergency response.

Therefore, it is desirable to provide a child seat that quickly discovers a child who is left behind in a parked vehicle, provides an immediate emergency response, and ensures safety of the child.

### Embodiment

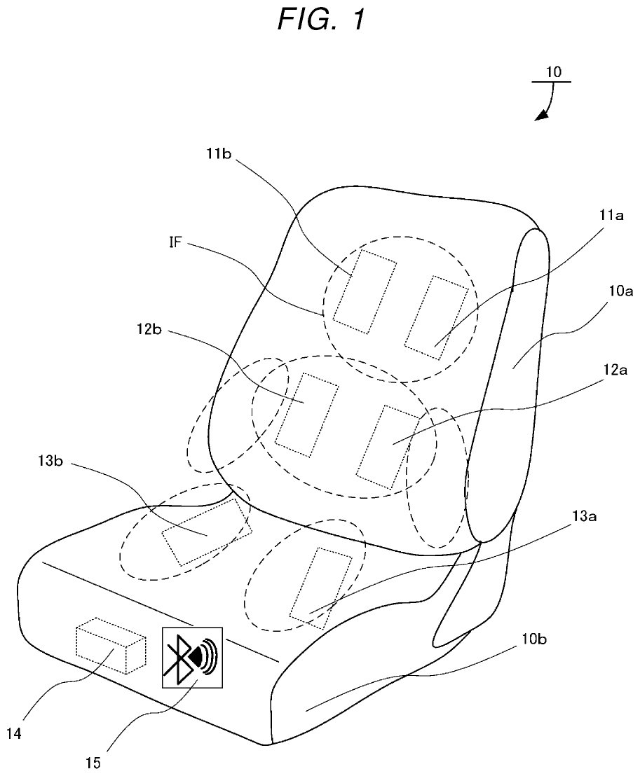

A child seat 10 according to the present embodiment will be described with reference to FIGS. 1 to 5. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

### Configuration of Child Seat 10

As illustrated in FIG. 1, the child seat 10 is provided with, for example, head sensors 11a and 11b, chest sensors 12a and 12b, and ischium sensors 13a and 13b, which correspond to a head, a chest, and an ischium of a child IF who is seated in the child seat 10.

The head sensors 11a and 11b, the chest sensors 12a and 12b, and the ischium sensors 13a and 13b are provided symmetrically on inner sides of surfaces of a seat back 10a and a seat unit 10b of the child seat 10. The surfaces are in contact with the child IF.

An ECU 14, a communicator 17, and a short-distance wireless antenna 15 are provided inside the child seat 10. In one embodiment, the ECU 14 may serve as a “detector”.

For example, the ECU 14 transmits a detection result by the detector based on output signals from the head sensors 11a and 11b, the chest sensors 12a and 12b, and the ischium sensors 13a and 13b to an external device 100 constituting a system, for example, an in-vehicle device, via the short-distance wireless antenna 15 by the communicator 17.

A transmission destination of the detection result is not limited to the in-vehicle device, and may be transmitted to a vehicle or an external device 100 such as a mobile terminal.

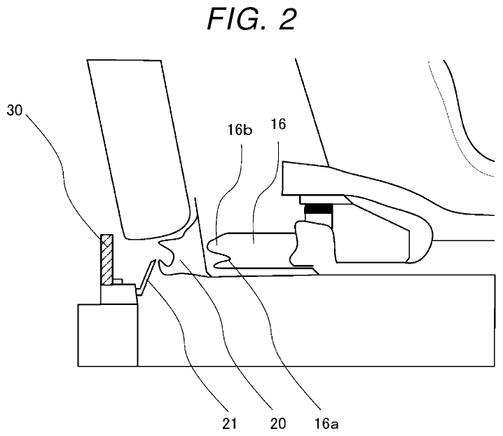

As illustrated in FIG. 2, the child seat 10 is provided with a fixing unit 16 that fixes the child seat 10 and a vehicle seat.

The fixing unit 16 is a conductive rod-shaped member extending in a vehicle front-rear direction on both end sides of a body bottom surface in a vehicle width direction. A vehicle rear end of the rod-shaped member comes into contact with an electrode 30 coupled to a battery and is energized, and supplies power to the head sensors 11a and 11b, the chest sensors 12a and 12b, the ischium sensors 13a and 13b, the ECU 14, and the communicator 17. In one embodiment, the fixing unit 16 may serve as a “power supply”, and the ECU 14 may serve as the “detector”. The fixing unit 16 is implemented by, for example, an ISOFix arm.

When the child seat 10 is slid to a vehicle rear side on the vehicle seat, the ISOFix arm serving as the fixing unit 16 slides an arm guide 20 provided in a gap defined in a lower seat back and a rear end of the seat unit of the vehicle seat, and is locked by fitting a recess 16a formed in a tip end of the ISOFix arm serving as the fixing unit 16 to an anchor 21 provided on a vehicle side.

An inner curved surface of the recess 16a is covered with an insulating member.

When the ISOFix arm serving as the fixing unit 16 slides to a lock position, an upper projection 16b thereof provided at the tip end comes into contact with the electrode 30 provided on the vehicle side.

In the electrode 30, a pair of an anode 30a and a cathode 30b are coupled to an anode or a cathode of a battery, respectively. The electrode 30 supplies power to the ECU 14, the head sensors 11a and 11b, the chest sensors 12a and 12b, and the ischium sensors 13a and 13b.

The head sensors 11a and 11b, the chest sensors 12a and 12b, and the ischium sensors 13a and 13b are, for example, load sensors, and in some embodiments, rubber sensors. Short-distance wireless is Bluetooth (registered trademark) in some embodiments.

### Electrical Configuration of Child Seat 10

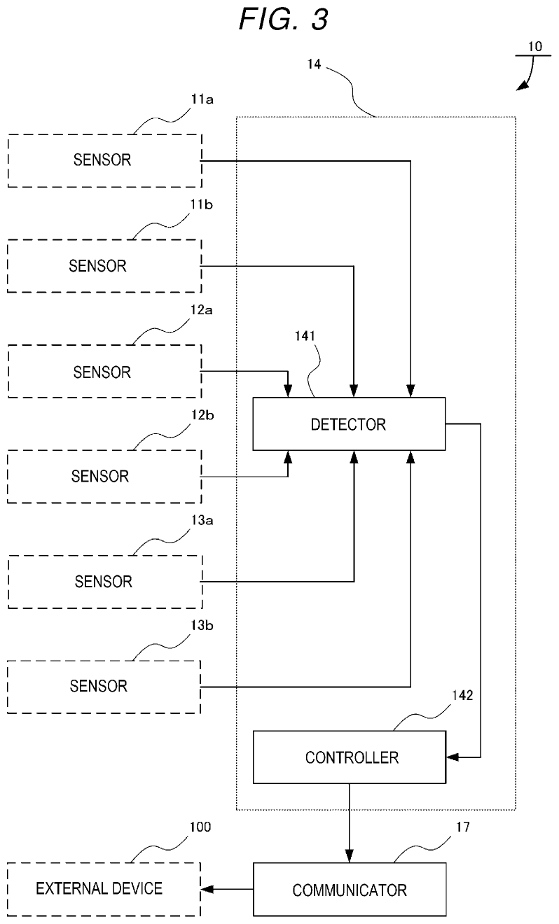

As illustrated in FIG. 3, the child seat 10 includes the ECU 14 and the communicator 17.

As illustrated in FIG. 3, the ECU 14 includes a detector 141 and a controller 142.

The detector 141 detects a position of a center of gravity of the seated child IF based on sensor signals from the head sensors 11a and 11b, the chest sensors 12a and 12b, and the ischium sensors 13a and 13b.

A detection result of the detector 141 is output to the controller 142 to be described later.

The controller 142 controls an overall operation of the ECU 14 and controls an operation of the communicator 17 to be described later based on a control program stored in a random access memory (RAM) (not illustrated).

In addition, the controller 142 controls power supply to the head sensors 11a and 11b, the chest sensors 12a and 12b, the ischium sensors 13a and 13b, and the communicator 17.

The communicator 17 executes short-distance wireless communication such as Bluetooth, and for example, transmits the detection result of the detector 141 to an external device 100 which is a part of the system, for example, the in-vehicle device, via the short-distance wireless antenna 15 based on the control of the controller 142.

### Processes of ECU 14

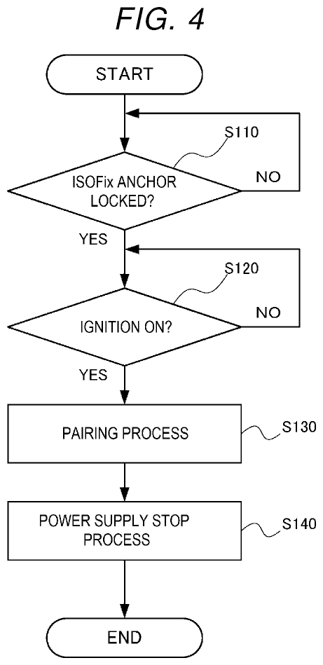

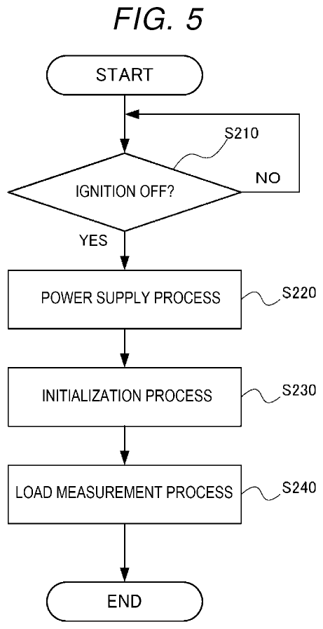

With reference to FIGS. 4 and 5, the processes of the ECU 14 of the child seat 10 according to the present embodiment will be described separately for processes when the child seat 10 is installed to the vehicle seat for the first time and normal processes.

### Processes When Child Seat 10 is Installed to Vehicle Seat for First Time

The controller 142 determines whether the ISOFix arm serving as the fixing unit 16 is in a locked state with respect to the anchor 21 (step S110).

When the controller 142 determines that the ISOFix arm serving as the fixing unit 16 is not in the locked state with respect to the anchor 21 (“NO” in step S110), the controller 142 returns the process to the original state and shifts to a standby mode.

On the other hand, when the controller 142 determines that the ISOFix arm serving as the fixing unit 16 is in the locked state with respect to the anchor 21 (“YES” in step S110), the controller 142 determines whether ignition is ON (step S120).

When the controller 142 determines that the ignition is not ON (“NO” in step S120), the controller 142 returns the process to the original state and shifts to the standby mode.

On the other hand, when the controller 142 determines that the ignition is ON (“YES” in step S120), the controller 142 causes the communicator 17 to execute a pairing process of Bluetooth (step S130).

Then, the controller 142 once shuts down the system and stops power supply to the head sensors 11a and 11b, the chest sensors 12a and 12b, the ischium sensors 13a and 13b, and the communicator 17 (step S140).

### Normal Processes

The controller 142 determines whether the ignition is OFF (step S210).

When the controller 142 determines that the ignition is not OFF (“NO” in step S210), the controller 142 returns the process to the original state and shifts to the standby mode.

On the other hand, when the controller 142 determines that the ignition is OFF (“YES” in step S210), the controller 142 starts power supply to the head sensors 11a and 11b, the chest sensors 12a and 12b, the ischium sensors 13a and 13b, and the communicator 17 to activate the system (step S220).

Next, the controller 142 executes an initialization process of a load measurement value by the detector 141.

For example, the controller 142 executes a process such as erasing data in a predetermined area of a memory (not illustrated) (step S230).

Then, the controller 142 executes a load measurement process of starting load measurement by the detector 141 (step S240).

### Operations and Advantageous Effects

As described above, the child seat 10 according to the present embodiment includes the sensors 11a, 11b, 12a, 12b, 13a, and 13b that are provided symmetrically on inner sides of surfaces of a seat back and a seat unit corresponding to at least a head, a chest, and an ischium of the child IF who is seated. The surfaces are in contact with the child IF.

Therefore, it is possible to detect a behavior of the child IF who is seated.

In addition, since the sensors 11a, 11b, 12a, 12b, 13a, and 13b are provided symmetrically to positions corresponding to the head, the chest, and the ischium of the child IF, the position of the center of gravity of the child IF who is seated can be detected based on a bias of loads of the sensors 11a, 11b, 12a, 12b, 13a, and 13b which are symmetrical.

Since the position of the center of gravity or a change in the position of the center of gravity, in other words, movement of shoulders in conjunction with a head and movement of a thigh or a shoulder blade in conjunction with movement of a waist can be acquired in real time, it is possible to accurately estimate a state of the child IF such as a state where the child IF is struggling.

In addition, there is a case where when the child IF is left behind in a vehicle cabin because the child IF is sleeping, a driver (who drives the vehicle) leaves the vehicle to run an errand, and the child seat is covered with a cloth to prevent the child IF from waking up in the way.

In such a case, whether the child is present in the child seat may not be determined from an image or the like, but the child seat 10 according to the present embodiment can accurately recognize presence of the child IF even in such a case.

Therefore, if a system using the child seat 10 according to the present embodiment is constructed, it is possible to provide an immediate emergency response to the child IF, and to ensure safety of the child IF.

The child seat 10 according to the present embodiment includes the detector 141 that detects a position of a center of gravity of a seated child based on the sensor signals from the sensors 11a, 11b, 12a, 12b, 13a, and 13b, and the communicator 17 that transmits the detection result of the detector 141.

That is, the child seat 10 also includes an electrical configuration that transmits the detection result of the detector 141 that detects the position of the center of gravity of the seated child IF.

Therefore, there is versatility that the child seat 10 according to the present embodiment can be used in any vehicle as long as power can be supplied.

In addition, if the system using the child seat 10 according to the present embodiment is constructed, it is possible to provide an immediate emergency response to the child IF, and to ensure safety of the child IF.

The child seat 10 according to the present embodiment includes the ISOFix arm serving as the fixing unit 16. The fixing unit 16 is the conductive rod-shaped member extending in the vehicle front-rear direction on both end sides of the body bottom surface in the vehicle width direction. The vehicle rear end of the rod-shaped member comes into contact with the electrode 30 coupled to a battery to be energized, and supplies power to the head sensors 11a and 11b, the chest sensors 12a and 12b, the ischium sensors 13a and 13b, the detector 141, and the communicator 17.

That is, if a pair of electrodes 30 coupled to the battery can be prepared, it is possible to detect the position of the center of gravity of the seated child IF and transmit a detection result thereof.

Therefore, if the pair of electrodes 30 coupled to the battery can be prepared, it is possible to construct the system using the child seat 10 according to the present embodiment, to provide an immediate emergency response to the child IF, and to ensure safety of the child IF.

In addition, in the present embodiment, since the electrodes 30 are installed on a back surface of the seat back of the vehicle seat, there is no risk of short-circuiting between the electrodes 30.

Further, in the present embodiment, since the electrodes 30 are installed deep in the gap defined in the lower seat back and the rear end of the seat unit of the vehicle seat, and the arm guide 20 is provided in front of the electrodes 30, possibility that a part of a human body touches the electrodes 30 and causes an electric shock is low.

The sensors 11a, 11b, 12a, 12b, 13a, and 13b of the child seat 10 according to the present embodiment are rubber sensors.

The rubber sensors are soft, thin, and excellent in bendability.

For this reason, the sensitive child IF can be prevented from struggling due to discomfort caused by a hardness, a shape (unevenness), a thickness, and the like of bodies of the head sensors 11a and 11b, the chest sensors 12a and 12b, and the ischium sensors 13a and 13b, and thus erroneous detection by the head sensors 11a and 11b, the chest sensors 12a and 12b, and the ischium sensors 13a and 13b can be prevented.

Therefore, if a system using the child seat 10 according to the present embodiment is constructed, it is possible to provide an immediate emergency response to the child IF, and to ensure safety of the child IF.

The child seat 10 of the disclosure can be implemented by recording the processes of the ECU 14 in a recording medium readable by a computer system and causing the ECU 14 to read and execute a program recorded in the recording medium. The computer system includes an OS and hardware such as a peripheral device.

In addition, the “computer system” also includes a homepage providing environment (or a display environment) when a world wide web (WWW) system is used. In addition, the program may be transmitted from a computer system having the program stored in a storage device or the like to another computer system via a transmission medium or by transmission waves in the transmission medium. Here, the “transmission medium” that transmits the program refers to a medium having a function of transmitting information, for example, a network (communication network) such as the Internet or a communication line such as a telephone line.

The above program may implement a part of the above-described functions. Further, the above program may be a program, that is, a so-called difference file (difference program), capable of implementing the above-described functions in combination with a program already recorded on the computer system.

Although the embodiments of the present disclosure have been described in detail with reference to the drawings, specific configurations are not limited to the embodiments, and designs and the like within a range not departing from the gist of the present disclosure are also included.

According to one or more embodiments of the disclosure, it is possible to quickly discover a child who is left behind in a parked vehicle, provide an immediate emergency response, and ensure safety of the child.

The ECU 14 illustrated in FIG. 3 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the ECU 14 illustrated in FIG. 3. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the ECU 14 illustrated in FIG. 3.

1. A child seat configured to be disposed on a vehicle seat in a vehicle, the child seat comprising:
sensors provided on inner sides of surfaces of a seat back and a seat unit corresponding to at least a head, a chest, and an ischium of a child who is seated on the child seat, the surfaces being in contact with the child;
a detector configured to perform a detection of a position of a center of gravity of the seated child based on sensor signals from the sensors; and
a communicator configured to transmit a result of the detection by the detector to an external device.

2. The child seat according to claim 1, further comprising:
a fixing unit extending in a vehicle front-rear direction of the vehicle on both end sides of a body bottom surface in a vehicle width direction of the vehicle, the fixing unit being configured to fix the child seat and the vehicle seat, wherein
the fixing unit comprises a power supply configured to supply power from the vehicle to the sensors, the detector, and the communicator.

3. The child seat according to claim 2, wherein the sensors are rubber sensors.

4. A child seat to be disposed on a vehicle seat in a vehicle, the child seat comprising:
sensors provided on inner sides of surfaces of a seat back and a seat unit corresponding to at least a head, a chest, and an ischium of a child who is seated on the child seat, the surfaces being in contact with the child; and
circuitry configured to
perform a detection of a position of a center of gravity of the seated child based on sensor signals from the sensors, and
cause a communicator to transmit a result of the detection to an external device.
